(19) United States
(12) Patent Application Publication
(10) Pub. No.: US 2012/0147220 A1
(43) Pub. Date: Jun. 14, 2012

(54) DIGITAL IMAGE PROCESSING APPARATUS FOR QUICKLY ENTERING INTO REPRODUCTION MODE AND METHOD OF CONTROLLING THE SAME

(75) Inventor: Myung-hun Lee, Suwon-si (KR)

(73) Assignee: Samsung Electronics Co., Ltd., Suwon-si (KR)

(21) Appl. No.: 13/268,215

(22) Filed: Oct. 7, 2011

(30) Foreign Application Priority Data
Dec. 10, 2010 (KR) 10-2010-0126351

(51) Int. Cl. H04N 5/76

(52) U.S. Cl. 348/231.99; 348/E05.022

(57) ABSTRACT

A method of controlling a digital image signal processing apparatus includes generating quick view image data corresponding to input image data, storing the quick view image data in a first area of a memory, entering into a reproduction mode, determining whether image signal processing performed on the input image data has been completed, and if it is determined that the image signal processing has not been completed in the reproduction mode, displaying a display image corresponding to the quick view image data stored in the first area of the memory.

### CROSS-REFERENCE TO RELATED PATENT APPLICATION

This application claims the priority benefit of Korean Patent Application No. 10-2010-0126351, filed on Dec. 10, 2010, in the Korean Intellectual Property Office, the entire disclosure of which is incorporated herein by reference.

### BACKGROUND

1. Field of the Invention

Embodiments generally relate to a digital image processing apparatus for quickly entering into a reproduction mode and a method of controlling the same.

2. Description of the Related Art

A digital camera sequentially image processes, compresses, and stores a captured image to perform image capturing. In a reproduction mode, the compressed and stored image is decompressed and displayed. However, when the digital camera enters into the reproduction mode immediately after capturing an input image with a large volume of raw data or after performing high-speed burst capturing, the digital camera enters into the reproduction mode before image processing has been completed, and thus, displaying an image on a display unit is significantly delayed.

### SUMMARY

Embodiments can provide a digital image processing apparatus for improving a speed of entering into a reproduction mode and a method of controlling the same.

According to an embodiment, there is provided a method of controlling a digital image signal processing apparatus. The method includes generating quick view image data corresponding to input image data, storing the quick view image data in a first area of a memory, entering into a reproduction mode, determining whether image signal processing performed on the input image data has been completed, and if it is determined that the image signal processing has not been completed in the reproduction mode, displaying a display image corresponding to the quick view image data stored in the first area of the memory.

The method may further include generating an image file by compressing the input image data, storing the image file in a second area of the memory, and storing display image data derived from the image file in the first area of the memory in the reproduction mode.

The first area of the memory may include sub areas, and in the reproduction mode, a portion of the sub areas of the first area stores the quick view image data, and a remaining portion of the sub areas of the first area stores the display image data.

The first area of the memory may include a first sub area and a second sub area. In a capturing mode, first quick view image data generated from first input image data is stored in the first sub area and second quick view image data generated from second input image data is stored in the second sub area, and in the reproduction mode, first display image data corresponding to the first input image data is stored in the first sub area and second display image data corresponding to the second input image data is stored in the second sub area.

According to another embodiment, there is provided a digital image signal processing apparatus. The digital image signal processing apparatus includes a quick view image generator that generates quick view image data corresponding to input image data, a memory that stores the quick view image data in a first area thereof, a reproduction mode execution unit that enters into a reproduction mode, a determiner that determines whether image signal processing performed on the input image data has been completed, and a display unit that displays a display image corresponding to the quick view image data stored in the first area of the memory, if the determiner determines that the image signal processing has not been completed in the reproduction mode.

The digital image signal processing apparatus may further include an image file generator that generates an image file by compressing the input image data, wherein the memory stores the image file in a second area of the memory and stores display image data derived from the image file in the first area of the memory in the reproduction mode.

The first area of the memory may include sub areas, and in the reproduction mode, a portion of the sub areas of the first area stores the quick view image data, and a remaining portion of the sub areas of the first area stores the display image data.

The first area of the memory may include a first sub area and a second sub area. In a capturing mode, first quick view image data generated from first input image data is stored in the first sub area and second quick view image data generated from second input image data is stored in the second sub area, and in the reproduction mode, first display image data corresponding to the first input image data is stored in the first sub area and second display image data corresponding to the second input image data is stored in the second sub area.

According to another embodiment, there is provided a method of controlling a digital image signal processing apparatus. The method includes generating input images, performing image processing on the input images with respect to a capture order, entering into a reproduction mode, determining whether the image processing performed on the input images has been completed, and if it is determined that the image processing has not been completed in the reproduction mode, performing the image processing on the input images with respect to a reproduction order.

After entering into the reproduction mode, the image processing performed with respect to the capture order may stop, and the image processing may be performed on the input images with respect to the reproduction order.

The image processing may be at least one selected from a group consisting of recording and displaying.

The reproduction order may be opposite to the capture order.

The input images may be generated by a single capturing signal.

According to another embodiment, there is provided a digital image signal processing apparatus. The digital image signal processing apparatus includes an image processor that performs image processing on input images with respect to a capture order, a reproduction mode execution unit that enters into a reproduction mode, and a determiner that determines whether the image processing performed on the input images has been completed. If the determiner determines that the image processing has not been completed in the reproduction mode, the image processor performs the image processing on the input images with respect to a reproduction order.

After entering into the reproduction mode, the image processor may stop the image processing performed in a capturing mode and may perform the image processing on the input images according to the reproduction order.

The image processing may be at least one selected from a group consisting of recording and displaying.

The reproduction order may be opposite to the capture order.

The input images may be inputted by a single capturing signal.

According to an embodiment, a speed of entering into a reproduction mode can be improved by sharing a predetermined area of a memory for storing image data for displaying in a capturing mode and the reproduction mode.

According to another embodiment, when entering into the reproduction mode in a state where image processing performed on captured images has not been completed, the reproduction mode can be quickly performed by changing an image processing order to a reproduction order.

### BRIEF DESCRIPTION OF THE DRAWINGS

The above and other features and advantages will become more apparent by describing in detail exemplary embodiments with reference to the attached drawings in which:

FIG. 1 is a front view of a digital image signal processing apparatus according to an exemplary embodiment;

FIG. 2 is a rear view of the digital image signal processing apparatus shown in FIG. 1;

FIG. 3 is a block diagram of the digital image signal processing apparatus shown in FIG. 1 and a control operation thereof;

FIG. 4 is a block diagram of an image signal processor and a Central Processing Unit (CPU) illustrated in FIG. 3, according to an exemplary embodiment;

FIGS. 5 and 6 show storage areas of a memory illustrated in FIG. 4, according to an exemplary embodiment;

FIG. 7 is a flowchart of a method of controlling a digital image signal processing apparatus, according to an exemplary embodiment;

FIG. 8 is a block diagram of the image signal processor and the CPU illustrated in FIG. 3, according to another exemplary embodiment; and

FIG. 9 is a diagram of a method of controlling a digital image signal processing apparatus, according to another exemplary embodiment.

### DETAILED DESCRIPTION

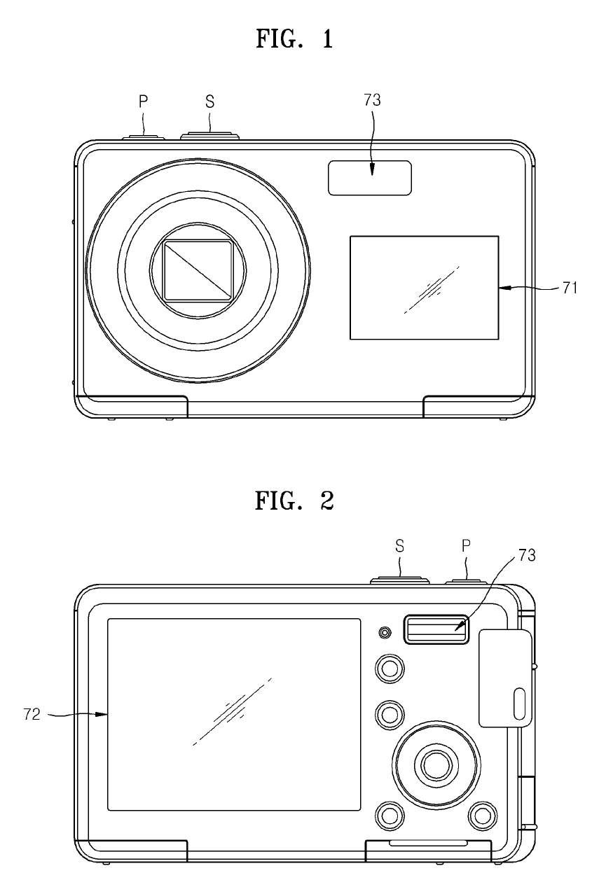

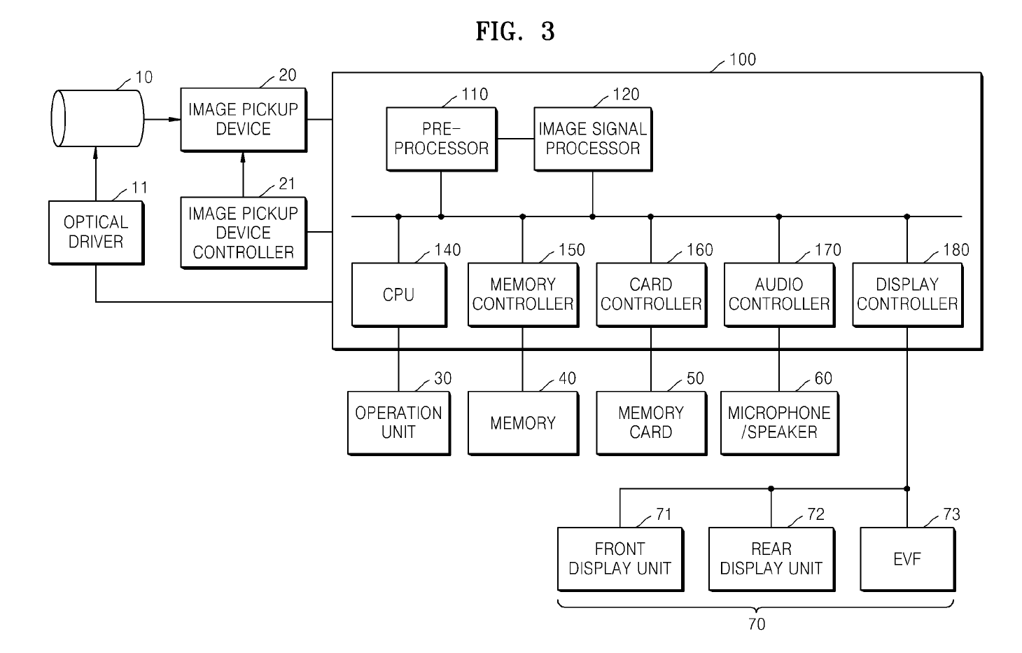

FIG. 1 is a front view of a digital image signal processing apparatus according to an exemplary embodiment, and FIG. 2 is a rear view of the digital image signal processing apparatus shown in FIG. 1.

Although the digital image signal processing apparatus is illustrated as a digital camera in the embodiment shown, embodiments are not limited thereto, and the digital image signal processing apparatus may be applied to other digital devices, such as a video camera, a Personal Digital Assistant (PDA), a television (TV), a digital picture frame, a mobile phone, and a Portable Multimedia Player (PMP).

Referring to FIGS. 1 and 2, a front display unit 71 and a lens may be disposed on a front side of the digital camera so that a subject can see the front display unit 71. A rear display unit 72 may be disposed on a rear side of the digital camera so that a photographer can see the rear display unit 72. In addition, an Electronic View Finder (EVF) 73 may be included in the digital camera.

The digital camera may include a shutter release button S that can input a capturing signal when manipulated by a user. In addition, the digital camera may include a power button P that can input an operation signal when manipulated by the user to turn the digital camera on or off. The shutter release button S and the power button P may be disposed on a grip part, e.g., on a top side thereof.

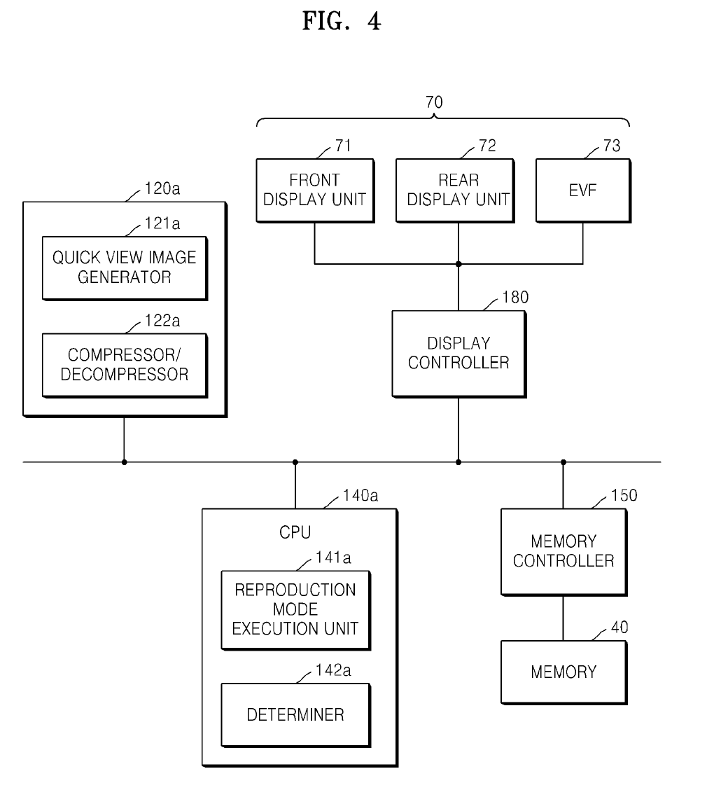

FIG. 3 is a block diagram of the digital camera shown in FIG. 1. Referring to FIG. 3, the digital camera may include an optical unit 10, an optical driver 11 that can drive the optical unit 10, an image pickup device 20, and an image pickup device controller 21.

The optical unit 10 may include an image focus optical system, a shutter, and an iris, wherein the image focus optical system may focus an optical signal from a subject. The image focus optical system may include a focus lens and a zoom lens that can adjust a focal distance. The optical driver 11 may include a focus lens driver that can adjust a position of the focus lens, an iris driver that can adjust an opening or closing of the iris, and a shutter driver that can adjust an opening or closing of the shutter.

The image pickup device 20 may generate an image signal by picking up image light passing through the image focus optical system. The image pickup device 20 may include a plurality of photoelectric converters arranged in a matrix pattern and a vertical and/or horizontal transmission path that can move electric charges from the plurality of photoelectric converters to derive an image signal. A Charge Coupled Device (CCD) sensor or a Complementary Metal Oxide Semiconductor (CMOS) sensor may be used as the image pickup device 20. The image pickup device controller 21 may control the image pickup device 20 to capture an image in synchronization with a timing signal.

In addition, the digital camera may include a controller 100. The controller 100 may include a pre-processor 110, an image signal processor 120, a Central Processing Unit (CPU) 140, a memory controller 150, a card controller 160, an audio controller 170, and a display controller 180.

The pre-processor 110 may calculate from the image signal acquired by the image pickup device 20 an Auto White Balance (AWB) evaluation value for adjusting white balance, an Auto Exposure (AE) evaluation value for adjusting exposure, and an Auto Focus (AF) evaluation value for adjusting a focus. For example, if the user half-presses the shutter release button S so that the digital camera can enter into an S1 state, the pre-processor 110 may calculate the AWB evaluation value, the AE evaluation value, and the AF evaluation value. The CPU 140 can control AWB, AE, and AF based on the AWB evaluation value, the AE evaluation value, and the AF evaluation value, respectively.

The image signal processor 120 may reduce noise of input image data and can perform image signal processing, such as gamma correction, color filter array interpolation, color matrix, color correction, and color enhancement. The image signal processor 120 may further recognize a subject or a specific scene by using brightness information, color information, and pattern information of the image data. For example, a face area may be detected from the image data by using a face recognition algorithm. A live-view image, a quick view image, a captured image, and a reproduced image may be generated by selectively performing the above-described image signal processes on the image data. In addition, compression with respect to the image signal processed image data may be performed to generate an image file. Decompression with respect to the image file may also be performed. For example, an image signal may be compressed in a compression format, such as a Joint Photographic Experts Group (JPEG) compression format or an H.264 compression format. The image file including the image data generated through compression may be stored in a memory card 50.

The CPU 140 may generally control an operation of each component according to a signal input by the user, a stored program, or an input image signal. The CPU 140 is described in more detail below with reference to the drawings.

The memory controller 150 may temporarily store captured images and various kinds of information in a memory 40 or output the captured images and the various kinds of information from the memory 40. In addition, the memory controller 150 may read program information stored in the memory 40.

The card controller 160 may store or read an image file in or from the memory card 50. In addition, the card controller 160 may control reading or storing of various kinds of information.

The audio controller 170 may control a microphone/speaker 60. The display controller 180 may control image display of the front display unit 71 and the rear display unit 72. The display controller 180 may also control image display of the EVF 73. Although the display controller 180 may commonly control the front display unit 71, the rear display unit 72, and the EVF 73 in the current embodiment, embodiments are not limited thereto, and separate display controllers may be respectively included for the front display unit 71, the rear display unit 72, and the EVF 73. The front display unit 71, the rear display unit 72, and the EVF 73 may be formed using any of various display devices, such as a Liquid Crystal Display (LCD) and an Organic Light Emitting Diode (OLED).

The digital camera may also include an operation unit 30 that can input an operation signal when manipulated by the user. The operation unit 30 may include various buttons, such as the shutter release button S, a main switch, a mode dial, and a menu button. Although buttons and dials can be included in the embodiment shown, embodiments are not limited thereto. The digital camera may include a touch panel of a display unit 70.

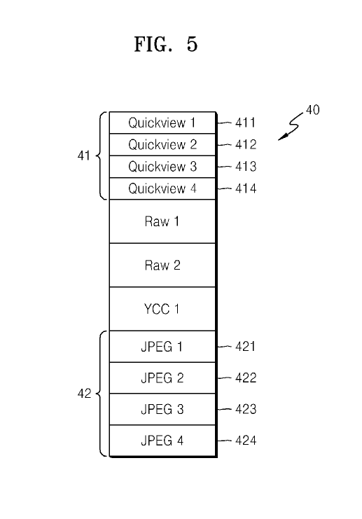

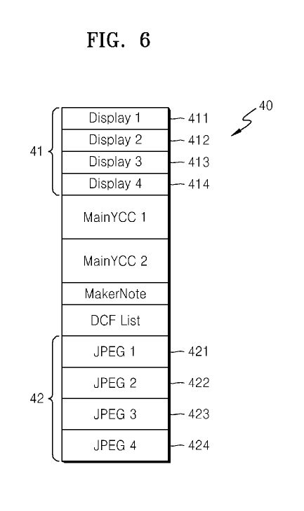

A digital camera that may use the same memory area in both a capturing mode and a reproduction mode is described with reference to FIG. 4 that illustrates a digital image signal processing apparatus according to an exemplary embodiment. Referring to FIG. 4, an image signal processor 120a according to an embodiment may include a quick view image generator 121a that can generate quick view image data corresponding to input image data and a compressor/decompressor 122a that can compress or decompress the input image data. The quick view image data may be stored in a first area of the memory 40 (for example, a first area 41 shown in FIG. 5). In the reproduction mode, a display image corresponding to the quick view image data stored in the first area of the memory 40 may be displayed on the display unit 70. That is, the display image may be displayed on at least one of the front display unit 71, the rear display unit 72, and the EVF 73.

A CPU 140a may include a reproduction mode execution unit 141a that can execute the reproduction mode when a reproduction mode switch command is inputted through an operation unit, such as operation unit 30. The CPU 140a may further include a determiner 142a that can determine whether image signal processing of the input image data has been completed before executing the reproduction mode.

For example, when burst capturing is performed by, for example, fully pressing the shutter release button S, a plurality of pieces of input image data may be generated with a single capturing control signal. Image signal processing for displaying and/or recording may be sequentially performed on the plurality of pieces of input image data. For example, when an image file is generated by performing signal processing related to image quality on the input image data and compressing the signal processed image data, it may be determined that the image signal processing has been completed. When the reproduction mode is executed while the image signal processing is being sequentially performed on the plurality of pieces of input image data inputted by the burst capturing, the determiner 142a may determine that the image signal processing has not been completed. Although burst capturing is described for the embodiment shown, embodiments are not limited thereto. The current embodiment may be applied to after capturing an image having a large volume of raw data or after a continuous capturing operation. This may also be applied to the embodiments described below.

The display unit 70 may display the display image corresponding to the quick view image data stored in the first area of the memory 40.

A virtual storage area of the memory 40 is described in detail with reference to FIGS. 5 and 6. FIG. 5 illustrates a storage area of the memory 40. Referring to FIG. 5, if the shutter release button S is fully pressed in a burst capturing mode, input image data Raw 1 and Raw 2 corresponding to a plurality of input images may be stored in the memory 40. The input image data Raw 1 may be converted to image data YCC 1 in a YCC color format and then the image data YCC 1 may be stored. Thereafter, an image file JPEG 1 may be generated by compressing the image data YCC 1 and stored in a second area 42. For other input image data, image files JPEG 2, JPEG 3, and JPEG 4 may be generated and stored in the second area 42.

In the embodiment shown, a quick view image for a quick view may be generated to check an image captured in the capturing mode. Thus, quick view image data Quickview 1, Quickview 2, Quickview 3, and Quickview 4 may be generated by performing image signal processing on the input image data Raw 1 and Raw 2 for quick view display and stored in sub areas 411 to 414 of the first area 41.

As described above, in the capturing mode, the memory 40 may include the first area 41 that can store quick view image data. In the burst capturing mode, the first area 41 can store a plurality of pieces of quick view image data.

In the reproduction mode, a storage area of the memory 40 may be configured as shown in FIG. 6. Compared to the capturing mode, display image data Display 1, Display 2, Display 3, and Display 4 may be stored in the sub areas 411 to 414 of the first area 41 for storing quick view image data in the memory 40.

The display image data Display 1 to Display 4 may be generated from decompressing the image files JPEG 1 to JPEG 4.

In the embodiment shown, when entering into the reproduction mode from the capturing mode in a state where image signal processing performed on captured input image data has not been completed, quick view image data may be stored in the first area 41 of the memory 40, so display images corresponding to the quick view image data may be displayed on a display unit. In the reproduction mode, display image data may be generated by decompressing image files stored in the second area 42 and stored in the first area 41. Accordingly, when entering into the reproduction mode from the capturing mode, the quick view image data may be temporarily stored in a portion of a plurality of sub areas 411 . . . 414 of the first area 41 of the memory 40, and the display image data generated from decompressing the image files may be stored in the remaining sub areas of the first area 41. Thus, in the embodiment shown, the first area 41 of the memory 40 may be set as an area that can store image data for displaying in both the capturing mode and the reproduction mode. The second area 42 of the memory 40 may also be commonly set as an area that can store image files in both the capturing mode and the reproduction mode.

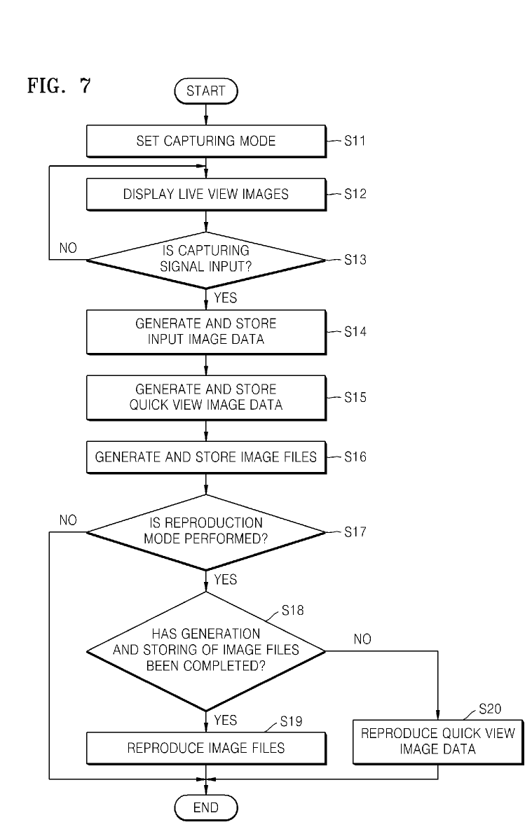

FIG. 7 is a flowchart of a method of controlling a digital image signal processing apparatus, according to an exemplary embodiment. Referring to FIG. 7, in operation S11, a capturing mode may be set. For example, a burst capturing mode may be set.

In operation S12, live view images inputted in the capturing mode may be displayed. A user can input a capturing signal at a proper time by checking the live view images. Also, the live view image display may be omitted. In addition, the capturing signal may be a signal for capturing a subject to be recorded and may be generated by fully pressing a shutter release button or automatically generated during self timer capturing.

In operation S13, it may be determined whether the capturing signal is inputted. If the capturing signal is not inputted, the live view images may be continuously displayed in operation S12.

If the capturing signal is inputted, input image data may be generated and stored in a memory in operation S14. The memory may be a buffer memory and may be a Synchronous Dynamic Random Access Memory (SDRAM).

In operation S15, quick view image data may be generated by performing image processing on the input image data for a quick view. The quick view image data may also be stored. The quick view image data may be stored in a first area of a memory. In burst capturing mode, quick view image data may be sequentially generated from input image data that has been sequentially inputted, and the quick view image data may be stored in a plurality of sub areas of the first area and may be temporarily displayed on a display unit.

In operation S16, image signal processing related to image quality set by the user and/or a manufacturer may be performed on the input image data. Image files may be generated by compressing the signal processed input image data and stored in a second area of the memory. Thereafter, the image files may be recorded in a memory card where they can be maintained regardless of power supply. In continuous capturing mode, the image signal processing and generating image files may be sequentially performed for a plurality of pieces of captured input image data.

In operation S17, it may be determined whether to enter into a reproduction mode. If the reproduction mode is entered into, it may be determined in operation S18 whether the generation and storing of image files has been completed. When entering into the reproduction mode from the burst capturing mode immediately after capturing a plurality of piece of input image data, the image signal processing for generating image files may not have been completed for some portion of the input image data. If the image signal processing for generating image files has been completed, the image files recorded in the memory card may be read and temporarily stored in the second area of the memory. Display image data may be generated by performing image signal processing related to displaying on the image files and stored in the first area of the memory.

Display images corresponding to the display image data may be displayed on the display unit in operation S19. A plurality of burst captured images may be displayed. However, if the generation and storing of image files has not been completed, display images may be displayed in correspondence with the quick view image data stored in the first area of the memory in the capturing mode in operation S20. While the display images corresponding to the quick view image data are being displayed, the image signal processing for generating image files may be performed on a portion of the input image data for which the generation and storing of image files has not been completed.

Meanwhile, while the display images corresponding to the quick view image data are being displayed in the reproduction mode, an operation related to the reproduction mode may be separately performed. For example, when entering into the reproduction mode while the image signal processing for generating image files is being performed after acquiring first to fourth pieces of input image data through burst capturing, the display images corresponding to the quick view image data already stored in the first area may be displayed. At the same time, display image data may be generated by completing the generation and storing of image files and decompressing image files generated and stored in the first area of the memory. Although the display images corresponding to the quick view image data are quickly displayed when quickly entering into the reproduction mode, an operation of generating the display image data by decompressing the image files generated and an operation of storing the display image data in the first area of the memory in preparation for magnified reproduction thereafter may be separately performed. Thus, in the reproduction mode, the quick view image data may be stored in a portion of the sub areas of the first area of the memory, and the display image data may be stored in the remaining sub areas of the first area of the memory.

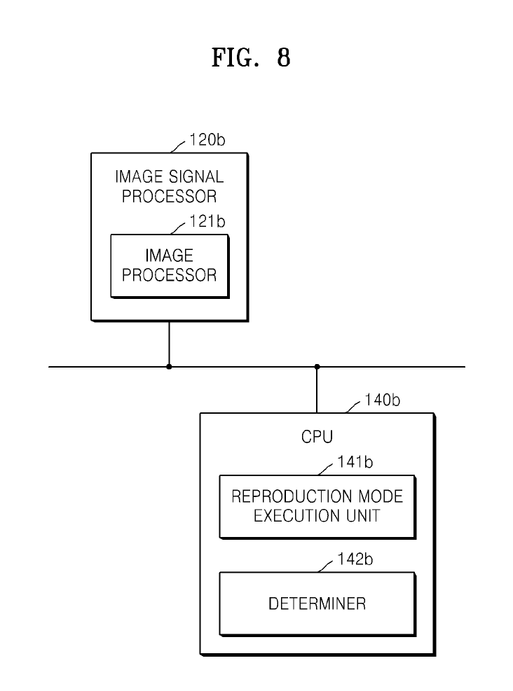

A digital camera trying to quickly enter into the reproduction mode by changing an image processing order is described with reference to FIG. 8 that illustrates a digital image signal processing apparatus according to another exemplary embodiment. In FIG. 8, only an image signal processor 120b and a CPU 140b corresponding to those of the digital camera shown in FIG. 3 is described in detail.

Referring to FIG. 8, the image signal processor 120b may perform image processing on a plurality of input images with respect to a capture order, i.e., an order in which the input images are captured. The image processing may also include a process of generating an image file by compressing image data, which has been described with reference to FIG. 3.

The CPU 140b may include a reproduction mode execution unit 141b that can enter into the reproduction mode and a determiner 142b that can determine whether image processing performed on input image data has been completed.

As determined by the determiner 142b, while in the reproduction mode, if the image processing has not been completed, an image processor 121b may perform image processing on the input image data with respect to a reproduction order. In particular, the image processor 121b may stop the image processing being performed with respect to the capture order after entering the reproduction mode and perform the image processing on the input image data with respect to the reproduction order. The image processing may be image processing for at least one selected from the group consisting of recording and displaying. In addition, the reproduction order may be opposite to the captured order.

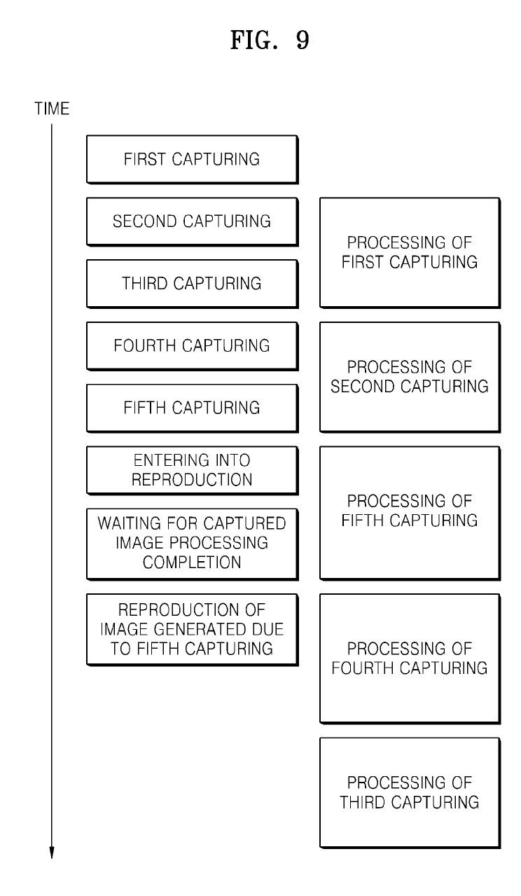

This is described with reference to FIG. 9. Referring to FIG. 9, when sequentially performing first capturing to fifth capturing with respect to a single capturing signal in the capturing mode, that is, the burst capturing mode, image processing may be performed on a first input image captured according to the first capturing, and image processing may be performed on a second input image captured according to the second capturing, as shown in the figure. After performing imaging processing with respect to the first through fifth capturings, the digital camera may enter into the reproduction mode. However, if image processing has only been performed with respect to the first and second capturings before the digital camera enters into the reproduction mode, image processing has not been performed for input images input from the third through fifth capturings. That is, when image processing has not been completed and the reproduction mode has been entered into, the digital camera first may perform image processing on an input image to be reproduced in order to quickly enter into the reproduction mode. In the embodiment shown, the reproduction order may be opposite to the capture order, and thus, an image generated from the fifth capturing may be first reproduced. That is, images may be reproduced in an order from newest to oldest. Thus, image processing may be first performed on the fifth input image acquired by the fifth capturing, and image processing may then be sequentially performed on input images acquired by the fourth capturing and the third capturing. Thus, the digital camera can quickly enter into the reproduction mode.

A method of controlling a digital image processing apparatus according to an embodiment may be embodied as computer readable codes on a computer readable recording medium. The computer readable recording medium is any data storage device that can store programs or data that can be thereafter read by a computer system. Examples of the computer readable recording medium are a flash memory and so forth.

An apparatus according to an embodiment may include a processor, a memory for storing program data to be executed by the processor, a permanent storage such as a disk drive, a communication port for performing communication with an external device, and a user interface, such as a touch panel, a key, and a button.

Methods implemented with a software module or an algorithm may be stored in or on a non-transitory computer readable recording medium in the form of computer readable codes or program instructions executable in the processor. Examples of the computer readable recording medium are magnetic storage media (e.g., read-only memory (ROM), random-access memory (RAM), floppy disks, hard disks, etc.) and optical recording media (e.g., CD-ROMs, Digital Versatile Discs (DVDs), etc.). The computer readable recording medium can also be distributed over network coupled computer systems so that the computer readable code is stored and executed in a distributed fashion. The media can be read by a computer, stored in the memory, and executed by the processor.

All references, including publications, patent applications, and patents, cited herein are hereby incorporated by reference to the same extent as if each reference were individually and specifically indicated to be incorporated by reference and were set forth in its entirety herein.

For the purposes of promoting an understanding of the principles of the invention, reference has been made to the embodiments illustrated in the drawings, and specific language has been used to describe these embodiments. However, no limitation of the scope of the invention is intended by this specific language, and the invention should be construed to encompass all embodiments that would normally occur to one of ordinary skill in the art. The terminology used herein is for the purpose of describing the particular embodiments and is not intended to be limiting of exemplary embodiments of the invention.

The invention can be represented with functional blocks and various processing steps. These functional blocks can be realized by any number of hardware and/or software components configured to perform the specified functions. For example, the invention may employ various integrated circuit components, e.g., memory elements, processing elements, logic elements, look-up tables, and the like, which may carry out a variety of functions under the control of one or more microprocessors or other control devices. Similarly, where the elements of the invention are implemented using software programming or software elements, the invention may be implemented with any programming or scripting language such as C, C++, Java, assembler, or the like, with the various algorithms being implemented with any combination of data structures, objects, processes, routines or other programming elements. Functional aspects may be implemented in algorithms that execute on one or more processors. Also, using the disclosure herein, programmers of ordinary skill in the art to which the invention pertains can easily implement functional programs, codes, and code segments for making and using the invention.

Furthermore, the invention may employ any number of conventional techniques for electronics configuration, signal processing and/or control, data processing and the like. The terms, such as “mechanism”, “element”, “means”, and “configuration”, are used broadly and are not limited to mechanical and physical configurations. The terms may include a series of software routines in association with a processor or processors.

Specific executions described herein are exemplary embodiments and do not limit the scope of the invention. For the sake of brevity, conventional electronics, control systems, software development and other functional aspects of the systems (and components of the individual operating components of the systems) may not be described in detail. In addition, connections or connection members of lines between components shown in the drawings illustrate functional connections and/or physical or circuit connections, and the connections or connection members can be represented by replaceable or additional various functional connections, physical connections, or circuit connections in an actual apparatus. It should be noted that many alternative or additional functional relationships, physical connections or logical connections may be present in a practical device. No item or component is essential to the practice of the invention unless the element is specifically described as “essential” or “critical”.

The use of the terms “a,” “an,” “the,” “said,” and similar referents in the context of describing the invention (especially in the context of the following claims) are to be construed to cover both the singular and the plural, unless the context clearly indicates otherwise. It will also be recognized that the terms “comprises,” “comprising,” “includes,” “including,” “has,” and “having,” as used herein, are specifically intended to be read as open-ended terms of art. The use of the terms “a” and “an” and “the” and similar referents in the context of describing the invention (especially in the context of the following claims) are to be construed to cover both the singular and the plural, unless the context clearly indicates otherwise. Also, it should be understood that although the terms “first,” “second,” etc. may be used herein to describe various elements, these elements should not be limited by these terms, which are only used to distinguish one element from another. In addition, recitation of ranges of values herein are merely intended to serve as a shorthand method of referring individually to each separate value falling within the range, unless otherwise indicated herein, and each separate value is incorporated into the specification as if it were individually recited herein. Finally, the steps of all methods described herein can be performed in any suitable order unless otherwise indicated herein or otherwise clearly contradicted by context. The invention is not necessarily limited to the disclosed order of the steps. The use of any and all examples, or exemplary language (e.g., “such as”) provided herein, is intended merely to better illuminate the invention and does not pose a limitation on the scope of the invention unless otherwise claimed. In addition, numerous modifications and adaptations will be readily apparent to those of ordinary skill in this art without departing from the spirit and scope of the present invention as defined by the following claims. Therefore, the scope of the invention is defined not by the detailed description of the invention but by the following claims, and all differences within the scope will be construed as being included in the invention.

What is claimed is:

1. A method of controlling a digital image signal processing apparatus, the method comprising:
generating quick view image data corresponding to input image data;
storing the quick view image data in a first area of a memory;
entering into a reproduction mode;
determining whether image signal processing performed on the input image data has been completed; and
if it is determined that the image signal processing has not been completed in the reproduction mode, displaying a display image corresponding to the quick view image data stored in the first area of the memory.

2. The method of claim 1, further comprising:
generating an image file by compressing the input image data;
storing the image file in a second area of the memory; and
storing display image data derived from the image file in the first area of the memory in the reproduction mode.

3. The method of claim 2, wherein the first area of the memory comprises a plurality of sub areas, and in the reproduction mode, a portion of the plurality of sub areas of the first area stores the quick view image data, and a remaining portion of the plurality of sub areas of the first area stores the display image data.

4. The method of claim 1, wherein the first area of the memory comprises a first sub area and a second sub area,
in a capturing mode, first quick view image data generated from first input image data is stored in the first sub area and second quick view image data generated from second input image data is stored in the second sub area, and
in the reproduction mode, first display image data corresponding to the first input image data is stored in the first sub area and second display image data corresponding to the second input image data is stored in the second sub area.

5. A digital image signal processing apparatus comprising:
a quick view image generator that generates quick view image data corresponding to input image data;
a memory that stores the quick view image data in a first area thereof;
a reproduction mode execution unit that enters into a reproduction mode;
a determiner that determines whether image signal processing performed on the input image data has been completed; and
a display unit that displays a display image corresponding to the quick view image data stored in the first area of the memory, if the determiner determines that the image signal processing has not been completed in the reproduction mode.

6. The digital image signal processing apparatus of claim 5, further comprising an image file generator that generates an image file by compressing the input image data,
wherein the memory stores the image file in a second area of the memory and stores display image data derived from the image file in the first area of the memory in the reproduction mode.

7. The digital image signal processing apparatus of claim 6, wherein the first area of the memory comprises a plurality of sub areas, and in the reproduction mode, a portion of the plurality of sub areas of the first area stores the quick view image data, and a remaining portion of the plurality of sub areas of the first area stores the display image data.

8. The digital image signal processing apparatus of claim 5, wherein the first area of the memory comprises a first sub area and a second sub area,
in a capturing mode, first quick view image data generated from first input image data is stored in the first sub area and second quick view image data generated from second input image data is stored in the second sub area, and
in the reproduction mode, first display image data corresponding to the first input image data is stored in the first sub area and second display image data corresponding to the second input image data is stored in the second sub area.

9. A method of controlling a digital image signal processing apparatus, the method comprising:
generating a plurality of input images;
performing image processing on the plurality of input images with respect to a capture order;
entering into a reproduction mode;
determining whether the image processing performed on the plurality of input images has been completed; and
if it is determined that the image processing has not been completed in the reproduction mode, performing the image processing on the plurality of input images with respect to a reproduction order.

10. The method of claim 9, wherein, after entering into the reproduction mode, the image processing performed with respect to the capture order stops, and the image processing is performed on the plurality of input images with respect to the reproduction order.

11. The method of claim 9, wherein the image processing is at least one selected from a group consisting of recording and displaying.

12. The method of claim 9, wherein the reproduction order is opposite to the capture order.

13. The method of claim 9, wherein the plurality of input images are generated by a single capturing signal.

14. A digital image signal processing apparatus comprising:
an image processor that performs image processing on a plurality of input images with respect to a capture order;
a reproduction mode execution unit that enters into a reproduction mode; and
a determiner that determines whether the image processing performed on the plurality of input images has been completed,
wherein if the determiner determines that the image processing has not been completed in the reproduction mode, the image processor performs the image processing on the plurality of input images with respect to a reproduction order.

15. The digital image signal processing apparatus of claim 14, wherein, after entering into the reproduction mode, the image processor stops the image processing performed in a capturing mode and performs the image processing on the plurality of input images according to the reproduction order.

16. The digital image signal processing apparatus of claim 14, wherein the image processing is at least one selected from a group consisting of recording and displaying.

17. The digital image signal processing apparatus of claim 15, wherein the reproduction order is opposite to the capture order.

18. The digital image signal processing apparatus of claim 14, wherein the plurality of input images are inputted by a single capturing signal.
